(19) United States
(12) Patent Application Publication
(10) Pub. No.: US 2026/0188702 A1
(43) Pub. Date: Jul. 2, 2026

(54) FABRIC OR TEXTILE-BASED FLEXIBLE BATTERY AND METHOD OF MAKING THE SAME

(71) Applicant: NavaFlex, Inc., Worthington, OH (US)

(72) Inventors: Suvankar Sengupta, Worthington, OH (US); Ramachandra Rao Revur, Worthington, OH (US); Amul Tevar, Worthington, OH (US)

(21) Appl. No.: 19/434,264

(22) Filed: Dec. 29, 2025

Related U.S. Application Data
(60) Provisional application No. 63/739,186, filed on Dec. 27, 2024.

(51) Int. Cl. H01M 4/74; H01M 4/02; H01M 4/525; H01M 4/583; H01M 4/62; H01M 10/04; H01M 10/0525; H01M 10/0565; H01M 10/0568; H01M 10/0569; H01M 50/109; H01M 50/171; H01M 50/426; H01M 50/434; H01M 50/446

(52) U.S. Cl. CPC H01M 4/747; H01M 4/525; H01M 4/583; H01M 4/623; H01M 4/625; H01M 10/0427; H01M 10/0525; H01M 10/0565; H01M 10/0568; H01M 10/0569; H01M 50/109; H01M 50/171; H01M 50/426; H01M 50/434; H01M 50/446; H01M 2004/027; H01M 2004/028; H01M 2300/004; H01M 2300/0082

(57) ABSTRACT

A flexible, textile integrated electrochemical cell comprising: a flexible cathode including a fabric containing a conductive material; a cathodic layer coated on the cathode; a flexible anode including a fabric containing a conductive material; an anodic layer coated on the anode; a PVDF/Al2O3 based separator; an electrolyte; and flexible current leads; wherein the flexible current leads are hermetically sealed and operatively coupled to the cathode and anode.

### CROSS REFERENCE TO RELATED APPLICATIONS

This application claims the priority benefit of U.S. Provisional Patent Application No. 63/739,186, filed Dec. 27, 2024, which is hereby incorporated by reference in its entirety.

### TECHNICAL FIELD

Disclosed embodiments relate to the field of fabric or textile-based flexible batteries and their fabrication. Disclosed embodiments may be seamlessly integrated into clothing and fabrics.

### BACKGROUND

Advancements in the field of electronics have resulted in the need for advancements in the field of batteries. As electronic devices become more flexible, stretchable, and mechanically deformable, there is a need for batteries that may have similar properties.

While several flexible batteries have been made and used, it is believed that no one prior to the inventors has made or used the invention described in the appended claims.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which.

FIG. 1A is an example spring like metal structure made according to the present disclosure;

FIG. 1B is another example spring like metal structure made according to the present disclosure;

FIG. 1C is yet another example spring like metal structure made according to the present disclosure;

FIG. 2 is a graph showing charge and discharge curves of a cell made according to Example 1 of the present disclosure;

FIG. 3 is a graph showing charge and discharge capacities of a cell made according to Example 1 of the present disclosure;

FIG. 4 is a graph showing charge and discharge capacities of a cell made according to Example 2 of the present disclosure;

FIG. 5 is a graph showing charge and discharge curves of a cell made according to Example 2 of the present disclosure; and

FIG. 6 is a graph showing charge and discharge capacities of a cell made according to Example 3 of the present disclosure.

The drawings are not intended to be limiting in any way, and it is contemplated that various versions of the technology may be carried out in a variety of other ways, including those not necessarily depicted in the drawings. The accompanying drawings incorporated in and forming a part of the specification illustrate several aspects of the present technology, and together with the description explain the principles of the technology; it being understood, however, that this technology is not limited to the precise arrangements shown.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

There is a need for a flexible or textile-based battery that combines the advantages of traditional lithium-ion batteries with the flexibility, lightweight nature, and breathability of textile materials. Fabrication of batteries of the present disclosure include cathodes, anodes, separators/electrolytes, current collectors, and sealants that are flexible and/or stretchable.

Within the confines of the present disclosure, the term flexible means that batteries of the present disclosure can bend, fold, twist, or stretch while still functioning properly. In one or more versions, batteries of the present disclosure are able to be bent 180 degrees or be folded in half, with no to a limited drop in performance (less than 10%). Cathodes, anodes, and separators of the batteries of the present disclosure are also able to flex independently.

In one or more embodiments, the flexible or textile-based batteries of the present disclosure include a flexible and stretchable cathode. In one or more embodiments, cathodes of the present disclosure include a fabric onto which a conductive material may be deposited, coated, or printed on. In one or more embodiments, the fabric may be selected from cotton, silk, polyester, nylon, rayon, or combinations thereof. In one or more embodiments, the fabric also includes a copolymer. In one or more embodiments, the fabric of the cathode may be 2-way stretchable or 4-way stretchable. 2-way stretch fabrics may stretch in one direction, usually from selvedge to selvedge (but may be in other directions depending on the knit) whereas 4-way stretch fabrics may stretch crosswise and lengthwise. Polyester used in accordance with versions described herein may be made stretchable by the inclusion of a copolymer such as polyurea, polyurethane, polyether, or copolymers thereof. In one or more embodiments, the stretchability of fabrics such as cotton, silk, and nylon may be enhanced through the addition of a copolymer such as polyurea.

The conductive material on the fabric of the cathode may include polyaniline (PANI), poly-pyrrole (PPy), poly(3,4-ethylenedioxythiophene polystyrene sulfonate (PEDOT:PSS), or combinations thereof. In one or more embodiments, the conductive material also includes metal particles, and the metal particles may include Aluminum (Al), Titanium (Ti), conductive carbon, graphene oxide (GO), or combinations thereof. In one or more embodiments, to enhance the conductivity of the cathode, a thin layer of Al may be deposited over the conductive material. In one or more embodiments, the Al layer may be deposited using electrophoresis or vacuum deposition.

Once the conductive fiber of the cathode has been created, it may then be printed or coated with a cathodic material that contains an active material, conductive filler, fiber material, binder, and an elastomeric material. In one or more embodiments, the cathodic material contains between 40% and 80% of the active material, between 5% and 20% of the binder, between 5% and 25% of the conductive filler, between 0% and 10% of the fiber material, and between 0% and 15% of the elastomeric material.

In one or more embodiments, the active material of the cathodic material effects the capacity of the flexible or textile-based batteries of the present disclosure. However, the capacity of the flexible or textile-based batteries of the present disclosure is generally not amplified by adding high amounts of the active material because higher amounts of the active material may reduce the flexibility of the cathode.

In one or more embodiments, the active material may include Lithium cobalt oxide (LiCoO₂), Lithium manganese oxide (LiMn₂O₄), Lithium nickel oxide (LiNiO₂), Lithium (cobalt, manganese, nickel) oxide {Li(Co,Mn,Ni)O₂], Lithium iron phosphate (LiFePO₄), Lithium (cobalt, nickel, aluminum) oxide {Li(Co,Mn,Al)O₂}, and combinations thereof. In one or more embodiments, the active material may be added to the cathodic material in the form of a powder and the particle size of the powder may vary from nanometers to microns and wherein the particles are random and/or fibrous shaped.

In one or more embodiments, the conductive filler of the cathodic material effects the electronic conductivity of the cathode. In one or more embodiments, the conductive filler may include conductive polymers such as PANI, PPy, PEDOT:PSS, or combinations thereof, or from conductive carbon.

In one or more embodiments, the fibers of the cathodic material effect the mechanical integrity of the cathode during bending. In one or more embodiments, the fibers may include Cellulose Nanofibrils, Carbon Nanofiber (CNF), Polyester fibers, Nylon fibers, Rayon fibers, Nano fibrillated fibers of Lyocell, Acrylic, and combinations thereof.

In one or more embodiments, the binder of the cathodic material combines together all the other materials that make up the cathodic material. In one or more embodiments, the binder may include Polyvinylidene fluoride (PVDF), poly(vinylidene fluoride-co-trifluoroethylene) (PVDF-TrFE), Styrene Butadiene Rubber (SBR), Polyacrylic Acid (PAA), polymer polytetrafluoroethylene (PTFE), poly(vinylidene fluoride-tetrafluoroethylenepropylene) (PVDF-TFE-P), poly(vinylidenefluoride-co-hexafluoropropylene) (PVDF-HFP), polyamide imide (PAI), polyethylene oxide (PEO), polyimide (PI), poly(acrylic acid) (PAA), poly(methyl methacrylate) (PMMA), polyvinyl alcohol (PVA), polypropylene carbonate (PPC), and combinations thereof.

In one or more embodiments, the elastomer of the cathodic material effects the stretchability and flexibility of the cathode. In one or more embodiments, the elastomer may include Polydimethylsiloxane (PDMS), styrene-butadiene block copolymers (SIBSTAR), Styrene Butadiene Rubber (SBR), polyisoprene, polyurethane, and combinations thereof.

In one or more embodiments, the flexible or textile-based batteries of the present disclosure include a flexible and stretchable anode. In one or more embodiments, anodes of the present disclosure include a fabric in which a conductive material may be deposited, coated, or printed on. In one or more embodiments, the fabric may be selected from cotton, silk, polyester, nylon, rayon, copper fabrics, or combination thereof. In one or more embodiments, the fabric also includes a copolymer. In one or more embodiments, the fabric of the anode may be 2-way stretchable or 4-way stretchable. Polyester used in accordance with versions described herein may be made stretchable by the inclusion of a copolymer such as polyurea polyurethane, polyether, or copolymers thereof. In one or more embodiments, the stretchability of fabrics such as cotton, silk, and nylon may be enhanced through the addition of a copolymer such as polyurea.

The conductive material on the fabric of the anode may include polyaniline (PANI), poly-pyrrole (PPy), poly(3,4-ethylenedioxythiophene polystyrene sulfonate (PEDOT:PSS), or combination thereof. In one or more embodiments, the conductive material also includes metal particles, and the metal particles may include Copper (Cu), graphite, silver, nickel, or combinations thereof. In one or more embodiments, to enhance the conductivity of the anode, a thin layer of copper, silver, nickel, or combinations thereof, may be deposited over the conductive material. In one or more embodiments, the Cu layer may be deposited using electrophoresis, colloidal deposition techniques, vacuum deposition, chemical vapor deposition, or combinations thereof.

Once the conductive fiber of the anode has been created, it may then be printed or coated with an anodic material that contains an active material, conductive filler, fiber material, binder, and an elastomeric material. In one or more embodiments, the anodic material contains between 60% and 85% of the active material, between 5% and 20% of the binder, between 0% and 10% of the conductive filler, between 0% and 10% of the fiber material, and between 0% and 15% of the elastomeric material.

In one or more embodiments, the active material of the anodic material effects the capacity of the flexible or textile-based batteries of the present disclosure. However, the capacity of the flexible or textile-based batteries of the present disclosure cannot just be amplified up by adding in high amounts of the active material because higher amounts of the active material may reduce the flexibility of the anode.

In one or more embodiments, the active material may include graphite, silicon, carbon/silicon composites, silicon dioxide (SiO₂), silicon monoxide (SiO), carbon/SiO₂ composites, tin, carbon/tin composites, Lithium Titanate (Li₄Ti₅O₁₂) and combinations thereof. In one or more embodiments, the active material may be added to the anodic material in the form of a powder and the particle size of the powder may vary from nanometers to microns and wherein the particles are random and/or fibrous shaped.

In one or more embodiments, the binder of the anodic material combines together all the other materials that make up the anodic material. In one or more embodiments, the binder may include PVDF, PVDF-TrFE, SBR, PAA, PTFE, PVDF-TFE-P, PVDF-HFP, PAI, PEO, PI, PAA, PMMA, PVA, PPC, and combinations thereof.

In one or more embodiments, the conductive filler of the anodic material effects the electronic conductivity of the anode. In one or more embodiments, the conductive filler may be most effective at increasing the electronic conductivity when Si, SiO, SiO₂, Sn, and Li₄Ti₁₅O₁₂ are used as the active material in the anodic material. In one or more embodiments, the conductive filler may include graphite, carbon, nanotubes, conductive carbon, copper powder, silver powder, and combinations thereof.

In one or more embodiments, the fibers of the anodic material effect the mechanical integrity of the anode during bending. In one or more embodiments, the fibers may include Cellulose Nanofibrils, CNF, Polyester fibers, Nylon fibers, Rayon fibers, Nano fibrillated fibers of Lyocell, Acrylic, and combinations thereof.

In one or more embodiments, the elastomer of the anodic material effects the stretchability and flexibility of the anode. In one or more embodiments, the elastomer may include PDMS, SIBSTAR, SBR, polyisoprene, polyurethane, and combinations thereof.

In one or more embodiments, the flexible or textile-based batteries of the present disclosure include a separator and/or an electrolyte that may be flexible and stretchable. In one or more embodiments, the flexible or textile-based batteries of the present disclosure include a separator such as the Pyrolux™ membrane. Pyrolux™ membranes are PVDF/Al₂O₃ based separators that are formed through a non-solvent induced phase inversion process that leads to a nanoscale and tunable hierarchal porosity. Pyrolux™ membranes are nonflammable and stable up to 200° C.

In one or more embodiments, the flexible or textile-based batteries of the present disclosure include an electrolyte, and the electrolyte may be a liquid, gel, or ionic liquid type electrolytes. In one or more embodiments, liquid electrolytes may include 1M LiPF₆ in EC/DEC, and 1 M LiPF₆ in EC/DMC/DEC. In one or more embodiments, gel electrolytes may include PVdF-hexafluoropropylene (HFP), Lithium bis(trifluoromethanesulfonyl)imide (LiTFSI)-Polyethylene glycol dimethyl ether (PEGDME). In one or more embodiments, ionic liquid electrolytes may include N-methyl-N-propylpiperidinium bis-(trifluoromethanesulfonyl)imide (PP13TFSI). The choice of electrolyte depends on the specific requirements of the flexible or textile-based battery, including factors such as energy density, safety, and operating conditions.

In one or more embodiments, the flexible or textile-based batteries of the present disclosure include current collectors that are flexible and stretchable. The current collectors connect the cathode and anode to an external load and provide power as needed to the flexible or textile-based batteries of the present disclosure. As stated above, the current collectors or the current lead also need to be flexible and stretchable. Furthermore, the leads need to be hermetically sealed so that no moisture or oxygen can penetrate and degrade the flexible or textile-based batteries of the present disclosure. In one or more embodiment, the current leads are welded or connected with conductive adhesive to the cathode and the anode. In one or more embodiments, a high temperature polymer tape may then be used to heat-seal the leads into position. However, the leads used in typical cells are not flexible and stretchable. The present disclosure contemplates two approaches to fabricate flexible and stretchable leads.

In a first approach, a flexible lead prepared by blending conductive polymer, an elastomer, and a metal powder may be fabricated. In one or more embodiments, the conductive polymer used to prepare the flexible leads are selected from PANI (Polyaniline), PP (Poly pyrrole), Polythiophene, Poly(3,4-ethylenedioxythiophene) Polystyrene sulfonate, and combinations thereof. In one or more embodiments, the elastomers used to prepare the flexible leads are selected from Poly-butyl acrylate/succinonitrile (PBA/SN), SiO₂/poly(propylene oxide), and combinations thereof. In one or more embodiments, the metal powder may act as a filler material to create the leads and may be selected from aluminum powder, copper powder, and combinations thereof. In one or more embodiments, the same metal powder may be used for the cathode leads and the anode leads, and in yet other embodiments, different metal powders may be used for the cathode leads and the anode leads. In one embodiment, aluminum powder may be used as a filler for the cathode leads and copper powder may be used for the anode leads. Once fabricated, the leads may be connected with the cathode and anode using a conductive adhesive, by ultrasonic welding, by spot welding, or combinations thereof. The leads may be sealed by using polymers like silicone or heat sealed using high temperature polymers.

In a second approach, the flexible leads may be fabricated utilizing a two-dimensional spring like metal structure embedded on a flexible polymer. In one or more embodiments, the metal structure may include aluminum, tin, nickel, copper, and combinations thereof. In one or more embodiments, the same metal structure may be used for the cathode leads and the anode leads, and in yet other embodiments, different metal structures may be used for the cathode leads and the anode leads. In one embodiment, aluminum or tin may be used as the metal structure for the cathode leads and nickel or copper metal structures may be used for the anode leads. In one or more embodiments, the flexible polymer may include Polydimethylsiloxane (PDMS), isobutylene-based thermoplastic elastomers such as SIBSTAR™ by Kaneka, KANEKAEPION™, INNOVIA SIBS.

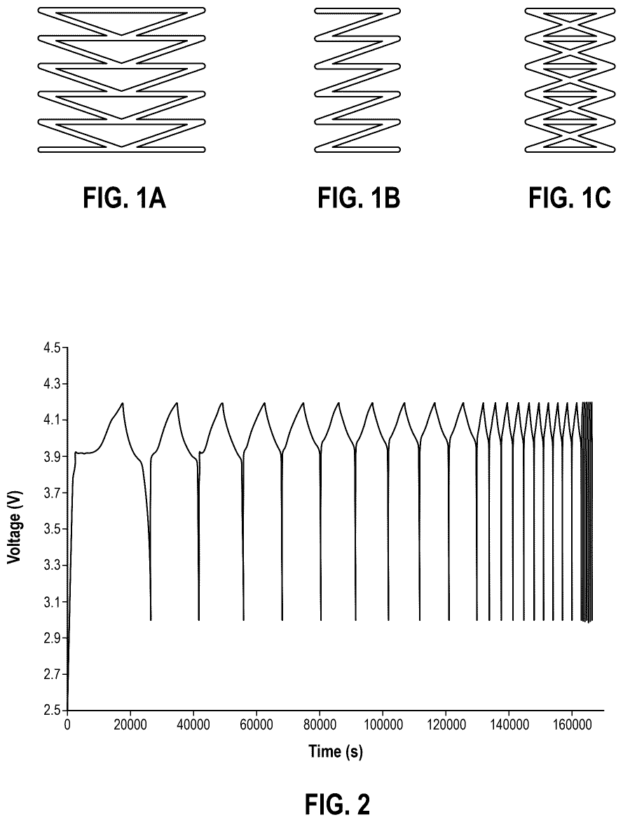

The metal structures may either be deposited onto the flexible polymer by vacuum deposition, sputtering, Chemical vapor deposition (CVD), or combinations thereof, or, in yet other embodiments, the metal structures may be cut from thin foils into two-dimensional shapes that are attached directly to the flexible polymer. Examples of flexible leads fabricated by this approach are shown in FIGS. 1A, 1B, and 1C. The fabricated leads may then be connected to the cathode and anode by using a conductive adhesive and a hermetic seal may be applied by using vacuum sealing using a high temperature polymer having a melting point between 12° and 150° C.

It may be apparent to those skilled in the art that various modifications and variations may be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

### EXAMPLES

Embodiments of the invention are now described in more detail with reference to the accompanying examples. It should be understood that these examples are provided for illustrative purposes and should not be construed as limiting the scope of the invention in any way.”

### Example 1: Cathode Coating on Fabric with Conventional Anode

In this example, a coin cell battery can be prepared which consists of a cathode coating deposited on to a fabric and an anode comprising copper foil and Celgard™ as a separator. Polyester cloth can be cut into a few pieces of 5 cm by 5 cm and can be used as a substrate to deposit the cathode coating. The cathode coating can consist of a composition of Lithium Cobalt Oxide (LCO) (60-90%), Carbon black (5-20%), and polyvinylidene fluoride (PVDF) (5-20%). Slurries can be prepared using NMP (N-methyl pyrrolidone) as a solvent. The coating can be created using a slot-die coating method and can then be dried in a vacuum oven at 80° C.

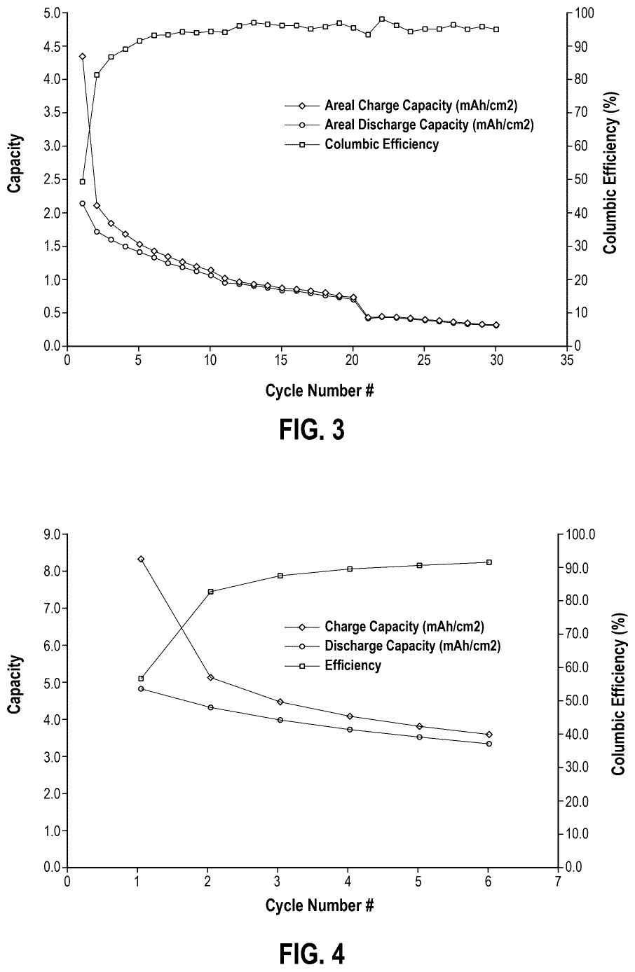

Different thickness of the coatings can be prepared ranging from 100 microns to 300 microns and the different coatings can be deposited on both sides of the polyester cloth fabric. Similarly, an anode can be prepared by using a composition of graphite (70-90%) and PVDF (10-30%) on a copper foil, utilizing a similar slot-die coating method. Anode film thickness can also vary from 100 microns to 300 microns. The slurries can be prepared using NMP (N-methyl pyrrolidone) as a solvent. Films can be dried under a vacuum oven at 80° C. Celgard™ can be used as a separator and two stainless steel spacers and one spring, and few microliters (300-500 uL) of liquid electrolyte LiPF₆ in ethylene carbonate and dimethyl carbonate (EC-DMC) can be used as an electrolyte to make a coin cell. The coin cell can then be crimped by using a crimping machine. This can all be performed inside a glove box with an argon gas atmosphere as the materials of the coin cell are air sensitive. In one embodiment, a cell made according to the above procedure was tested by connecting to a battery tester at different C rates and results are shown in FIGS. 2 and 3. C rate in a battery is the measurement of current in which a battery is charged or discharged at. A 1 C rate means that the discharge current will discharge the entire battery in 1 hour and C/2 means discharges in two hours and C/5 means it discharges in 5 hours and so on. FIG. 2 is a time vs. voltage plot showing the charge discharge cycles between 3V and 4.2V at different C rates. FIG. 3 shows that charging and discharging capacities of the cell in mAh/cm² and columbic efficiency percentage.

These results show the successful construction and operation of a battery using a fabric-based cathode architecture. By utilizing a polyester cloth substrate coated with a mixture of Lithium Cobalt Oxide (LCO), carbon black, and PVDF, researchers created a functional cathode that, when assembled with a graphite anode, Celgard separator, and liquid electrolyte, produces a working battery device. The voltage cycling between 3V and 4.2V, along with the measurable capacity in mAh/cm² and recorded coulombic efficiency, confirms that the textile-based cathode can effectively participate in lithium-ion storage and transport processes. These results validate that conventional fabrics can serve as viable substrates for battery electrodes while maintaining expected electrochemical performance characteristics of traditional lithium-ion batteries.

### Example 2: Battery Prepared with Cathode Coating on a Fabric and Anode Coating on a Fabric

In this example, a coin cell battery can be prepared which consists of a cathode coating deposited on to a fabric, an anode coating deposited onto a copper fabric, and Celgard™ as a separator. A polyester cloth can be cut into a few pieces of 5 cm by 5 cm and can be used as a substrate to deposit the cathode coating. The cathode coating can consist of a composition of LCO (60-90%), Carbon black (5-20%), and PVDF (5-20%). Slurries can be prepared using NMP (N-methyl pyrrolidone) as a solvent. The coating can be created using a slot-die coating method and can then be dried in a vacuum oven at 80° C. Different thickness of the coatings can be prepared ranging from 100 microns to 300 microns and the coatings can then be deposited on both sides of the fabric.

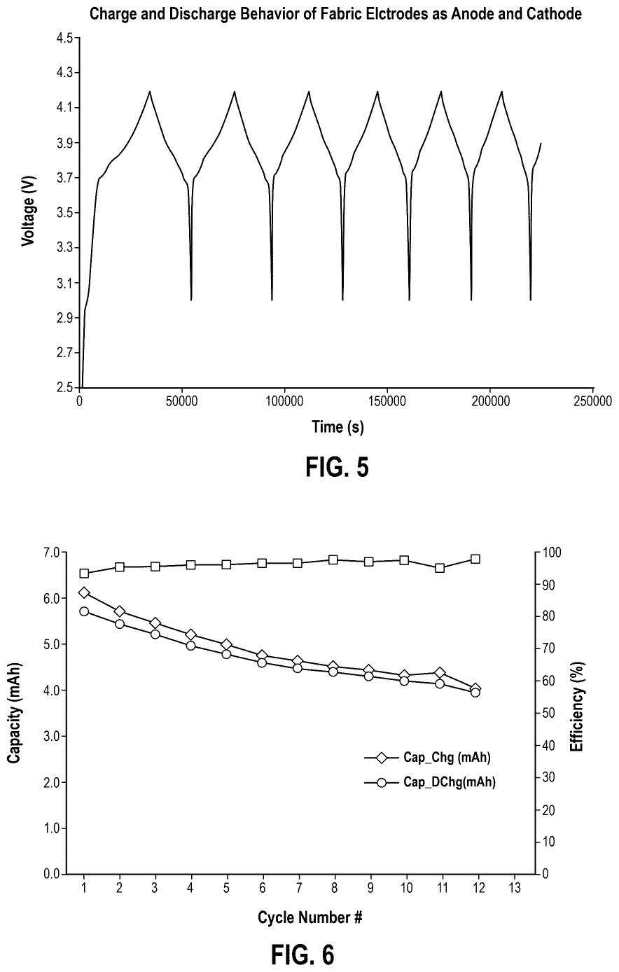

Similarly, an anode can be prepared by using a composition of graphite (70-90%) and PVDF (10-30%) on a copper fabric, by a similar slot-die coating method. Anode film thickness can also vary from 100 microns to 300 microns. Slurries can be prepared using NMP (N-methyl pyrrolidone) as a solvent. The films can be dried under a vacuum oven at 80° C. Celgard™ can be used as a separator and two stainless steel spacers and one spring, and a few microliters (300-500 uL) of liquid electrolyte LiPF₆ in EC-DMC can be used as an electrolyte to make a coin cell. The coin cell can then be crimped by using a crimping machine. This can all be performed inside a glove box with an argon gas atmosphere as the materials of the coin cell are air sensitive. In one embodiment, a cell made according to the above procedure was tested by connecting to a battery tester at constant current and results are shown in FIGS. 4 and 5. FIG. 4 shows the charge and discharge capacities (mAh/cm²) and the columbic efficiency (%) of the cell. FIG. 5 shows the charge and discharge curves as voltage vs. time at a constant current.

These results show a detailed methodology for fabricating a fabric-based lithium-ion coin cell battery where both electrodes utilize textile substrates. The cathode is constructed by coating a polyester fabric (5 cm×5 cm) with a slurry mixture of LCO (60-90%), carbon black (5-20%), and PVDF (5-20%), while the anode is prepared by coating a copper fabric with a mixture of graphite (70-90%) and PVDF (10-30%). Both electrodes are manufactured using a slot-die coating technique, with coating thicknesses ranging from 100 to 300 microns, and the cathode coating is applied to both sides of the fabric. The battery assembly process, conducted in an argon-filled glove box due to the air-sensitive nature of the materials, includes a Celgard separator, stainless steel spacers, a spring, and LiPF₆ in EC-DMC as the liquid electrolyte. The performance data, presented in FIGS. 4 and 5, demonstrates the battery's electrochemical behavior through charge-discharge capacity measurements (mAh/cm²), coulombic efficiency (%), and voltage-time profiles at constant current, validating the functionality of this textile-based battery design.

### Example 3: Battery Prepared with an Anode Coating on a Fabric

In this example, a coin cell battery can be prepared which consists of an anode coating deposited on to a copper fabric and a cathode coating deposited on a standard aluminum foil, and Celgard™ as a separator. A copper fabric can be cut into a few pieces of 5 cm by 5 cm and can be used as a substrate to deposit an anode coating. The anode coating can be prepared by using a composition of graphite (70-90%) and PVDF (10-30%) utilizing a slot-die coating method. Different anode film thickness can also be varied from 100 microns to 300 microns. Slurries can be prepared using NMP (N-methyl pyrrolidone) as a solvent. For the cathode, standard aluminum foil can be taken and cut into a few pieces of 5 cm by 5 cm and used as a substrate to deposit a cathode coating.

The cathode coating can be prepared by using a composition of LCO (60-90%), Carbon black (5-20%), and PVDF (5-20%). Slurries can be prepared using NMP (N-methyl pyrrolidone) as a solvent. These cathode coatings can be prepared using a slot-die coating method and dried in a vacuum oven at 80° C. Different thickness of the coatings can be prepared ranging from 100 microns to 300 microns and the coatings can be deposited on both sides of the fabric. The films can be dried in a vacuum oven at 80° C. Celgard™ can be used as a separator and two stainless steel spacers and one spring, and a few microliters (300-500 uL) of liquid electrolyte LiPF₆ in EC-DMC can be used as an electrolyte to make the coin cell. The coin cell can then be crimped by using a crimping machine. This can all be performed inside a glove box with an argon gas atmosphere as they are air sensitive. In one embodiment, a cell made according to the above procedure was tested by connecting to a battery tester at a constant current and the results are shown in FIG. 6 which shows the charge and discharge capacities (mAh/cm²) of the battery prepared according to the method of Example 3.

This data describes the fabrication and testing of a hybrid lithium-ion coin cell battery that combines traditional and textile-based electrode architectures. The battery design features an anode made by coating a copper fabric substrate (5 cm×5 cm) with a graphite (70-90%) and PVDF (10-30%) mixture, while the cathode uses a conventional aluminum foil substrate coated with LCO (60-90%), carbon black (5-20%), and PVDF (5-20%). Both electrodes are manufactured using the slot-die coating method with thicknesses ranging from 100 to 300 microns, and both utilize NMP as the slurry solvent. The cell assembly, performed in an argon-filled glove box, incorporates a Celgard separator, stainless steel spacers, a spring, and LiPF6 in EC-DMC as the liquid electrolyte. The performance data presented in FIG. 6, showing charge-discharge capacities in mAh/cm², demonstrates the functionality of this hybrid design that combines a fabric-based anode with a traditional metal foil cathode.

### Illustrative Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A flexible, textile integrated electrochemical cell comprising: a flexible cathode including a fabric containing a conductive material; a cathodic layer coated on the cathode; a flexible anode including a fabric containing a conductive material; an anodic layer coated on the anode; a PVDF/Al₂O₃ based separator; an electrolyte; and flexible current leads; wherein the flexible current leads are hermetically sealed and operatively coupled to the cathode and anode.

### Example 2

The electrochemical cell of Example 1, wherein the fabric of both the cathode and the anode may be selected from cotton, silk, polyester, nylon, rayon, or combinations thereof.

### Example 3

The electrochemical cell of Example 1, wherein the conductive material of both the cathode and the anode may be selected from polyaniline (PANI), poly-pyrrole (PPy), poly(3,4-ethylenedioxythiophene polystyrene sulfonate (PEDOT:PSS), or combinations thereof.

### Example 4

The electrochemical cell of Example 3, wherein the conductive material of the cathode further includes metal particles selected from Aluminum (Al), Titanium (Ti), conductive carbon, graphene oxide (GO), or combinations thereof, and wherein the conductive material of the anode further includes metal particles selected from Copper (Cu), graphite, silver, nickel, or combinations thereof.

### Example 5

The electrochemical cell of Example 1, wherein the cathodic layer comprises an active material, a conductive filler, fiber material, binder, and an elastomeric material.

### Example 6

The electrochemical cell of Example 5, wherein the active material is selected from Lithium cobalt oxide (LiCoO₂), Lithium manganese oxide (LiMn₂O₄), Lithium nickel oxide (LiNiO₂), Lithium (cobalt, manganese, nickel) oxide {Li(Co,Mn,Ni)O₂], Lithium iron phosphate (LiFePO₄), Lithium (cobalt, nickel, aluminum) oxide {Li(Co,Mn,Al)O₂}, and combinations thereof, wherein the conductive filler is selected from PANI, PPy, PEDOT:PSS, conductive carbon, or combinations thereof, wherein the fiber material is selected from cellulose nanofibrils, carbon nanofiber (CNF), polyester fibers, nylon fibers, rayon fibers, nano fibrillated fibers of lyocell, acrylic, and combinations thereof, wherein the binder is selected from Polyvinylidene fluoride (PVDF), poly(vinylidene fluoride-co-trifluoroethylene) (PVDF-TrFE), Styrene Butadiene Rubber (SBR), Polyacrylic Acid (PAA), polymer polytetrafluoroethylene (PTFE), poly(vinylidene fluoride-tetrafluoroethylenepropylene) (PVDF-TFE-P), poly(vinylidenefluoride-co-hexafluoropropylene) (PVDF-HFP), polyamide imide (PAI), polyethylene oxide (PEO), polyimide (PI), poly(acrylic acid) (PAA), poly(methyl methacrylate) (PMMA), polyvinyl alcohol (PVA), polypropylene carbonate (PPC), and combinations thereof, and wherein the elastomeric material is selected from Polydimethylsiloxane (PDMS), styrene-butadiene block copolymers (SIBSTAR), Styrene Butadiene Rubber (SBR), polyisoprene, polyurethane, and combinations thereof.

### Example 7

The electrochemical cell of Example 1, wherein the anodic layer comprises an active material, a conductive filler, fiber material, binder, and an elastomeric material.

### Example 8

The electrochemical cell of Example 7, wherein the active material is selected from graphite, silicon, carbon/silicon composites, silicon dioxide (SiO₂), silicon monoxide (SiO), carbon/SiO₂ composites, tin, carbon/tin composites, Lithium Titanate (Li₄Ti₅O₁₂) and combinations thereof; wherein the conductive filler is selected from graphite, carbon, nanotubes, conductive carbon, copper powder, silver powder, and combinations thereof, wherein the fiber material is selected from cellulose nanofibrils, carbon nanofiber (CNF), polyester fibers, nylon fibers, rayon fibers, nano fibrillated fibers of lyocell, acrylic, and combinations thereof, wherein the binder is selected from PVDF, PVDF-TrFE, SBR, PAA, PTFE, PVDF-TFE-P, PVDF-HFP, PAL PEO, PI, PAA, PMMMA, PVA, PPC, and combinations thereof; and wherein the elastomeric material is selected from Polydimethylsiloxane (PDMS), styrene-butadiene block copolymers (SIBSTAR), Styrene Butadiene Rubber (SBR), polyisoprene, polyurethane, and combinations thereof.

### Example 9

The electrochemical cell of Example 1, wherein the electrolyte is selected from a liquid electrolyte, a gel electrolyte, or an ionic liquid electrolyte.

### Example 10

The electrochemical cell of Example 9, wherein the electrolyte is a liquid electrolyte selected from 1M LiPF₆ in EC/DEC or 1 M LiPF₆ in EC/DMC/DEC.

### Example 11

The electrochemical cell of Example 9, wherein the electrolyte is a gel electrolyte selected from PVdF-hexafluoropropylene (HFP), Lithium bis(trifluoromethanesulfonyl)imide (LiTFSI), or Polyethylene glycol dimethyl ether (PEGDME).

### Example 12

The electrochemical cell of Example 9, wherein the electrolyte is a N-methyl-N-propylpiperidinium bis-(trifluoromethanesulfonyl)imide (PP13TFSI) ionic liquid electrolyte.

### Example 13

A method of manufacturing a flexible, textile-integrated electrochemical cell; the method comprising: providing a flexible cathodic fabric; forming a conductive layer on the cathodic fabric to form a conductive cathodic fabric; applying a cathodic layer on the conductive cathodic fabric to form a cathode; providing a flexible anodic fabric; forming a conducting layer on the cathodic fabric to form a conductive anodic fabric; applying an anodic layer on the conductive anodic fabric to form an anode; combining the cathode and anode with a PVDF/Al₂O₃ based separator and an electrolyte to form an electrochemical cell core; connecting flexible current leads to the cathode and anode; and hermetically sealing the current leads to form the flexible, textile-integrated electrochemical cell.

### Example 14

The method of Example 13; wherein the step of providing a flexible cathodic fabric further includes incorporating a copolymer selected from polyurea, polyurethane, polyether, or combinations thereof.

### Example 15

The method of Example 13, wherein the step of forming a conductive layer on the cathodic fabric to form a conductive cathodic fabric includes depositing, coating, or printing a conductive polymer selected from PANI, PPy, PEDOT:PSS, or combinations thereof.

### Example 16

The method of Example 13, wherein the step of applying a cathodic layer on the conductive cathodic fabric to form a cathode includes forming a cathodic slurry; and wherein the cathodic slurry includes an active material, a conductive filler, fiber material, binder, and an elastomeric material.

### Example 17

The method of Example 13, wherein the step of providing a flexible anodic fabric includes incorporating a copolymer selected from polyurea, polyurethane, polyether, or combinations thereof.

### Example 18

The method of Example 13, wherein the step of forming a conductive layer on the anodic fabric to form a conductive anodic fabric includes depositing, coating, or printing a conductive polymer selected from PANI, PPy, PEDOT:PSS, or combinations thereof.

### Example 19

The method of Example 13, wherein the step of applying an anodic layer on the conductive anodic fabric to form an anode include forming an anodic slurry; and wherein the anodic slurry includes an active material, a conductive filler, fiber material, binder, and an elastomeric material.

### Example 20

The method of Example 13, wherein the step of hermetically sealing the current leads is accomplished through the use of conductive adhesive or through heat-sealing.

### MISCELLANEOUS

It should be understood that any of the versions of the flexible, textile integrated electrochemical cells or methods of making the same described herein may include various other features in addition to or in lieu of those described above. By way of example only, any of the flexible, textile integrated electrochemical cells or methods of making the same described herein may also include one or more of the various features disclosed in any of the various references that are incorporated by reference herein. It should also be understood that the teachings herein may be readily applied to any of the flexible, textile integrated electrochemical cells or methods of making the same described in any of the other references cited herein, such that the teachings herein may be readily combined with the teachings of any of the references cited herein in numerous ways. Other types of flexible, textile integrated electrochemical cells or methods of making the same into which the teachings herein may be incorporated will be apparent to those of ordinary skill in the art.

It should also be understood that any ranges of values referred to herein should be read to include the upper and lower boundaries of such ranges. For instance, a range expressed as ranging “between approximately 1.0 inches and approximately 1.5 inches” should be read to include approximately 1.0 inches and approximately 1.5 inches, in addition to including the values between those upper and lower boundaries.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. A flexible, textile-integrated electrochemical cell comprising:
a flexible cathode including a fabric containing a conductive material;
a cathodic layer coated on the cathode;
a flexible anode including a fabric containing a conductive material;
an anodic layer coated on the anode;
a PVDF/Al₂O₃ based separator;
an electrolyte; and
flexible current leads;
wherein the flexible current leads are hermetically sealed and operatively coupled to the cathode and anode.

2. The electrochemical cell of claim 1, wherein the fabric of both the cathode and the anode may be selected from cotton, silk, polyester, nylon, rayon, or combinations thereof.

3. The electrochemical cell of claim 1, wherein the conductive material of both the cathode and the anode may be selected from polyaniline (PANI), poly-pyrrole (PPy), poly(3,4-ethylenedioxythiophene polystyrene sulfonate (PEDOT:PSS), or combinations thereof.

4. The electrochemical cell of claim 3, wherein the conductive material of the cathode further includes metal particles selected from Aluminum (Al), Titanium (Ti), conductive carbon, graphene oxide (GO), or combinations thereof, and wherein the conductive material of the anode further includes metal particles selected from Copper (Cu), graphite, silver, nickel, or combinations thereof.

5. The electrochemical cell of claim 1, wherein the cathodic layer comprises an active material, a conductive filler, fiber material, binder, and an elastomeric material.

6. The electrochemical cell of claim 5, wherein the active material is selected from Lithium cobalt oxide (LiCoO₂), Lithium manganese oxide (LiMn₂O₄), Lithium nickel oxide (LiNiO₂), Lithium (cobalt, manganese, nickel) oxide {Li(Co,Mn,Ni)O₂], Lithium iron phosphate (LiFePO₄), Lithium (cobalt, nickel, aluminum) oxide {Li(Co,Mn,Al)O₂}, and combinations thereof, wherein the conductive filler is selected from PANI, PPy, PEDOT:PSS, conductive carbon, or combinations thereof, wherein the fiber material is selected from cellulose nanofibrils, carbon nanofiber (CNF), polyester fibers, nylon fibers, rayon fibers, nano fibrillated fibers of lyocell, acrylic, and combinations thereof, wherein the binder is selected from Polyvinylidene fluoride (PVDF), poly(vinylidene fluoride-co-trifluoroethylene) (PVDF-TrFE), Styrene Butadiene Rubber (SBR), Polyacrylic Acid (PAA), polymer polytetrafluoroethylene (PTFE), poly(vinylidene fluoride-tetrafluoroethylenepropylene) (PVDF-TFE-P), poly(vinylidenefluoride-co-hexafluoropropylene) (PVDF-HFP), polyamide imide (PAI), polyethylene oxide (PEO), polyimide (PI), poly(acrylic acid) (PAA), poly(methyl methacrylate) (PMMA), polyvinyl alcohol (PVA), polypropylene carbonate (PPC), and combinations thereof, and wherein the elastomeric material is selected from Polydimethylsiloxane (PDMS), styrene-butadiene block copolymers (SIBSTAR), Styrene Butadiene Rubber (SBR), polyisoprene, polyurethane, and combinations thereof.

7. The electrochemical cell of claim 1, wherein the anodic layer comprises an active material, a conductive filler, fiber material, binder, and an elastomeric material.

8. The electrochemical cell of claim 7, wherein the active material is selected from graphite, silicon, carbon/silicon composites, silicon dioxide (SiO₂), silicon monoxide (SiO), carbon/SiO₂ composites, tin, carbon/tin composites, Lithium Titanate (Li₄Ti₅O₁₂) and combinations thereof, wherein the conductive filler is selected from graphite, carbon, nanotubes, conductive carbon, copper powder, silver powder, and combinations thereof, wherein the fiber material is selected from cellulose nanofibrils, carbon nanofiber (CNF), polyester fibers, nylon fibers, rayon fibers, nano fibrillated fibers of lyocell, acrylic, and combinations thereof, wherein the binder is selected from PVDF, PVDF-TrFE, SBR, PAA, PTFE, PVDF-TFE-P, PVDF-HFP, PAI, PEO, PI, PAA, PMMA, PVA, PPC, and combinations thereof; and wherein the elastomeric material is selected from Polydimethylsiloxane (PDMS), styrene-butadiene block copolymers (SIBSTAR), Styrene Butadiene Rubber (SBR), polyisoprene, polyurethane, and combinations thereof.

9. The electrochemical cell of claim 1, wherein the electrolyte is selected from a liquid electrolyte, a gel electrolyte, or an ionic liquid electrolyte.

10. The electrochemical cell of claim 9, wherein the electrolyte is a liquid electrolyte selected from 1M LiPF₆ in EC/DEC or 1 M LiPF₆ in EC/DMC/DEC.

11. The electrochemical cell of claim 9, wherein the electrolyte is a gel electrolyte selected from PVdF-hexafluoropropylene (HFP), Lithium bis(trifluoromethanesulfonyl)imide (LiTFSI), or Polyethylene glycol dimethyl ether (PEGDME).

12. The electrochemical cell of claim 9, wherein the electrolyte is a N-methyl-N-propylpiperidinium bis-(trifluoromethanesulfonyl) imide (PP13TFSI) ionic liquid electrolyte.

13. A method of manufacturing a flexible, textile-integrated electrochemical cell; the method comprising:
providing a flexible cathodic fabric;
forming a conductive layer on the cathodic fabric to form a conductive cathodic fabric;
applying a cathodic layer on the conductive cathodic fabric to form a cathode;
providing a flexible anodic fabric;
forming a conducting layer on the cathodic fabric to form a conductive anodic fabric;
applying an anodic layer on the conductive anodic fabric to form an anode;
combining the cathode and anode with a PVDF/Al₂O₃ based separator and an electrolyte to form an electrochemical cell core;
connecting flexible current leads to the cathode and anode; and
hermetically sealing the current leads to form the flexible, textile-integrated electrochemical cell.

14. The method of claim 13; wherein the step of providing a flexible cathodic fabric further includes incorporating a copolymer selected from polyurea, polyurethane, polyether, or combinations thereof.

15. The method of claim 13, wherein the step of forming a conductive layer on the cathodic fabric to form a conductive cathodic fabric includes depositing, coating, or printing a conductive polymer selected from PANI, PPy, PEDOT:PSS, or combinations thereof.

16. The method of claim 13, wherein the step of applying a cathodic layer on the conductive cathodic fabric to form a cathode includes forming a cathodic slurry; and wherein the cathodic slurry includes an active material, a conductive filler, fiber material, binder, and an elastomeric material.

17. The method of claim 13, wherein the step of providing a flexible anodic fabric includes incorporating a copolymer selected from polyurea, polyurethane, polyether, or combinations thereof.

18. The method of claim 13, wherein the step of forming a conductive layer on the anodic fabric to form a conductive anodic fabric includes depositing, coating, or printing a conductive polymer selected from PANI, PPy, PEDOT:PSS, or combinations thereof.

19. The method of claim 13, wherein the step of applying an anodic layer on the conductive anodic fabric to form an anode include forming an anodic slurry; and wherein the anodic slurry includes an active material, a conductive filler, fiber material, binder, and an elastomeric material.

20. The method of claim 13, wherein the step of hermetically sealing the current leads is accomplished through the use of conductive adhesive or through heat-sealing.
